(19) United States
(12) Patent Application Publication
(10) Pub. No.: US 2016/0256985 A1
(43) Pub. Date: Sep. 8, 2016

(54) Hub Lock Rotation Tool

(71) Applicant: Raymond Floyd, Cody, WY (US)

(72) Inventor: Raymond Floyd, Cody, WY (US)

(73) Assignee: Raymond Floyd, Cody, WY (US)

(21) Appl. No.: 14/636,234

(22) Filed: Mar. 3, 2015

(51) Int. Cl. B25B 13/48

(52) U.S. Cl. CPC B25B 13/481

(57) ABSTRACT

In some four wheel drive vehicles, the front wheels may have to be manually engaged through the rotation of a selector knob on the front axle to the LOCKED position. Rotation of the selector knob may be difficult due to the tightness of the knob, the engaging mechanism, or the depth of the knob in reference to the outer rim of the wheel hubcap. This tool provides application of additional torque to assist in the selector knob rotation as well as length to access the recessed selector knobs.

### FIELD OF THE INVENTION

This invention relates to a tool used to provide additional torque to the lock/unlock selector knob on four-wheel drive vehicles.

### BACKGROUND

Many four-wheel drive vehicles require that the normal non-drive axle be engaged through the movement of a selector knob on the end of the axle from the unlock position to the lock position (or vice versa to remove the lock condition). The selector knobs may move easily or they may become more difficult over time due to corrosion, dirt, or other material which may interfere with the rotational movement. The problem may be more exaggerated in older people who may have limited thumb pressure capability due to arthritis or similar problems.

There are also some wheel hub caps that have the selector knob recessed to a degree that makes the selection process extremely difficult for the user.

### SUMMARY OF THE INVENTION

In a preferred embodiment, the present invention is the design and implementation of an assembly that provides a connection to be applied to the four-wheel drive selector knob which will allow the user to apply greater torque to the selector knob, thus permitting the rotation to be completed without stressing the user's thumb joint.

### BRIEF DESCRIPTION OF THE DRAWINGS

FIG. 1 is the general layout of the preferred embodiment of the hub rotation tool.

FIG. 2 is a detailed layout of the preferred embodiment of the hub rotation tool illustrating the rotation of the common part to form the whole of the tool.

FIG. 3 is a detailed layout of the preferred embodiment of the hub rotation tool illustrating the tool in final configuration.

### DETAILED DESCRIPTION OF THE PREFERRED EMBODIMENT

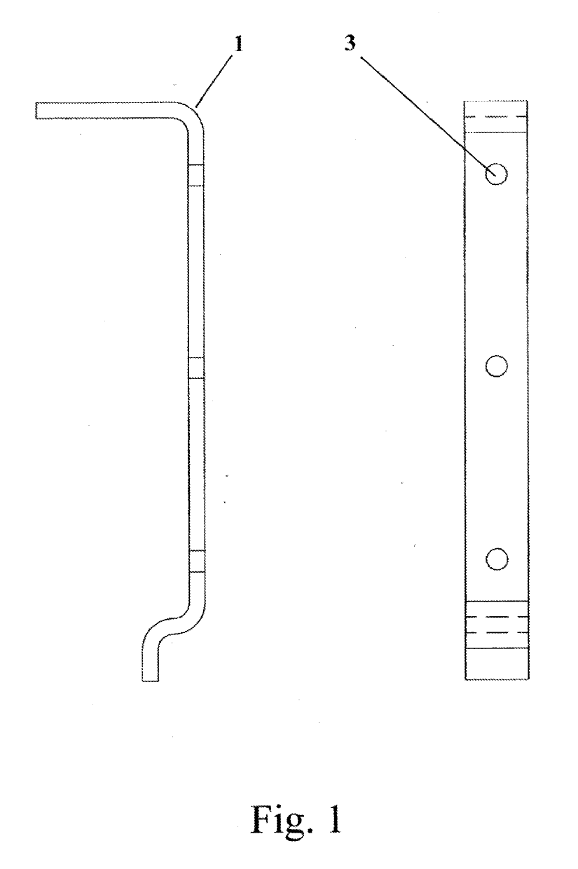

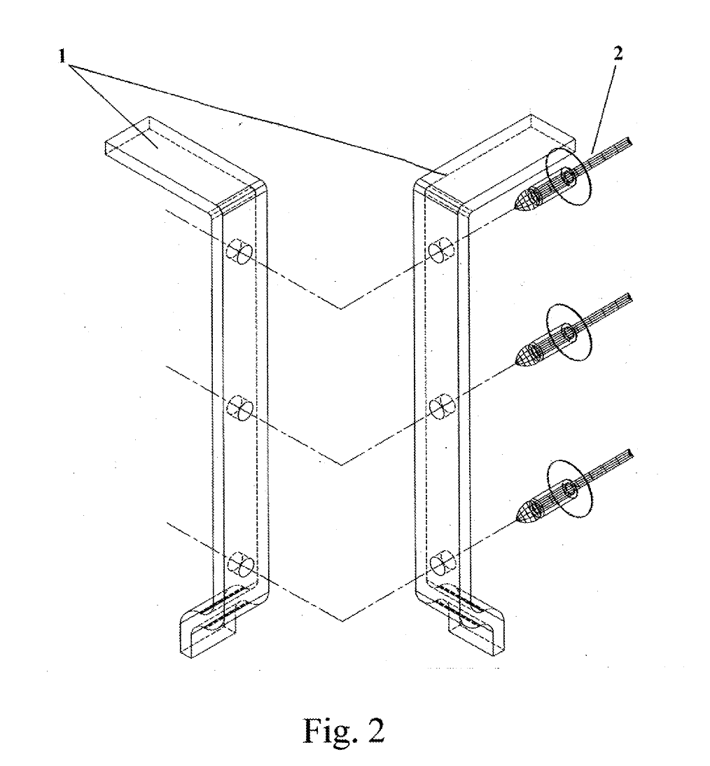

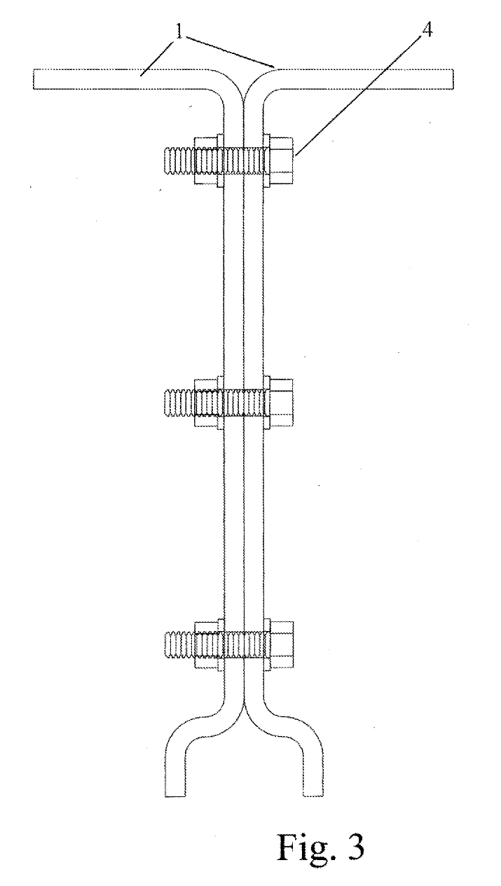

The general layout of the parts of the preferred embodiment of the four-wheel drive hub rotation tool is illustrated in FIG. 1. The unit is assembled of two parts 1 with one side rotated 180-degrees to match the second piece. Each piece of the tool has three holes 3 to provide spots for fasteners, joining the two pieces in a solid tool body. In the preferred embodiment, the assembly is configured from aluminum strap, however it could be implemented in steel strap, round rebar, or reinforced fiber materials. FIG. 2 illustrates the two tool body halves 1 and a typical device for joining the two, in the illustration, pop-rivets 2. Other means of fastening the two pieces could be binding posts, nuts and bolts, or welded as best fits the manufacturing process employed. FIG. 3 illustrates the complete hub rotation tool 1 with the joining devices being nut and bolt assemblies 4.

As illustrated in FIG. 3, the end opposite the T arms 1 can be used to straddle the hub lock/unlock rotation knob, thus providing torque in either the direction to the lock rotation position or the unlock rotation position of the knob rotation knob.

What is claimed is:

1. A “T” shaped tool comprised of:
two identical parts attached together;
fasteners joining the two parts together.

2. A tool of claim 1 which provides a handle on one end.

3. A tool of claim 1 which provides a torque application device on one end, permitting additional torque to the LOCK/UNLOCK drive selector.
